(19) United States
(12) Patent Application Publication
(10) Pub. No.: US 2024/0118990 A1
(43) Pub. Date: Apr. 11, 2024

(54) MONITORING A COMPUTER SYSTEM

(71) Applicant: INTERNATIONAL BUSINESS MACHINES CORPORATION, ARMONK, NY (US)

(72) Inventors: DANIEL TARASEK, Krakow (PL); Lukasz Janus, Krakow (PL)

(21) Appl. No.: 18/064,722

(22) Filed: Dec. 12, 2022

(30) Foreign Application Priority Data
Oct. 11, 2022 (GB) 2214945.4

(51) Int. Cl. G06F 11/34; G06F 9/455

(52) U.S. Cl. CPC G06F 11/3495; G06F 9/45558; G06F 2009/45591

(57) ABSTRACT

The present disclosure relates to method for monitoring a computer system. The computer system comprises a first processing unit and a monitoring unit for monitoring operation of the computer system. The method comprises: providing the computer system with a converter unit that is configured to communicate with the monitoring unit and the first processing unit. The converter unit may receive monitoring data from the monitoring unit. The received monitoring data may be pre-processed at the converter unit. The converter unit may send the resulting pre-processed data to at least one remote management system.

### BACKGROUND

The present invention relates to the field of digital computer systems, and more specifically, to a method for monitoring a computer system.

Preventing downtime in computer systems of a data centre may be a high priority for data centre administrators. The availability of the computer systems may enable users to access information or resources without interruptions. For that, computer systems may be monitored during their operation. However, there is a continuous need to improve the monitoring of such systems.

### SUMMARY

Various embodiments provide a method for monitoring a computer system, computer program product and processing unit as described by the subject matter of the independent claims. Advantageous embodiments are described in the dependent claims. Embodiments of the present invention can be freely combined with each other if they are not mutually exclusive.

In one aspect, the invention relates to a method for monitoring a computer system, the computer system comprising a first processing unit, the computer system further comprising a monitoring unit for monitoring operation of the computer system. The method comprises providing the computer system with a second processing unit that is configured to communicate with the monitoring unit and the main processing unit. The method further comprises receiving at the converter unit monitoring data from the monitoring unit. The method further comprises (a pre-processing step of) pre-processing the received monitoring data at the converter unit. The method further comprises (a sending step of) sending the resulting pre-processed data by the converter unit to at least one remote management system. The first processing unit may be referred to as main processing unit. The second processing unit may be referred to as converter unit.

In one aspect the invention relates to a computer program product comprising a computer-readable storage medium having computer-readable program code embodied therewith, the computer-readable program code configured to implement the method of the above embodiment.

In one aspect the invention relates to a processing unit (referred to as converter unit) for a computer system, the computer system comprising a first processing unit, the computer system further comprising a monitoring unit for monitoring operation of the computer system. The processing unit is configured for: receiving monitoring data from the monitoring unit; pre-processing the received monitoring data; sending the resulting pre-processed data to at least one remote management system.

### BRIEF DESCRIPTION OF THE DRAWINGS

In the following embodiments of the invention are explained in greater detail, by way of example only, making reference to the drawings in which:

FIG. 1 depicts a management system in accordance with an example of the present subject matter.

FIG. 2 depicts a block diagram of an example implementation of the main processing unit.

FIG. 3 depicts a block diagram of an example implementation of the converter unit.

FIG. 4 depicts a block diagram of an example implementation of the converter unit.

FIG. 5 depicts a motherboard for a computer system in accordance with an example of the present subject matter.

FIG. 6 depicts a management system in accordance with an example of the present subject matter.

FIG. 7 is a flowchart of a method for monitoring a computer system according to an example of the present subject matter.

FIG. 8 depicts a computing environment in accordance with an example of the present subject matter.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The monitoring unit may be configured to collect or acquire monitoring data e.g., in the form of time series data. The monitoring data may track changes over time of monitoring parameters. The monitoring parameters may comprise environment parameters, hardware parameters and/or software parameters. The environment parameters may comprise a room temperature of a room where the computer system is located, room humidity, etc. The hardware parameters may comprise fan speed, voltage, current, etc. The software parameters may comprise parameters that may be measured by an operating system of the main processing unit such as CPU usage, memory usage of one or more applications at the main processing unit. The monitoring data may enable to control the operation of the computer system to keep the performance of the computer system in agreement with performance requirements, e.g., as defined by a quality of service (QoS). For example, the monitoring data may be used to take timely and effective service actions in case of a detected malfunction related to the computer system. A malfunction may, for example, be that the value or the behaviour of one or more monitoring parameters is different from a reference behaviour. This may, for example, prevent downtime which may be a high priority in data centres comprising computer systems.

When a malfunction (e.g., an event that results in computing downtime) occurs, a user (e.g., administrator) of the remote management system may access the computer system remotely and fix the malfunction. The remote management system may be another computer system that is not part of the computer system comprising the converter unit. The remote management system may be referred to as an external system. The external system is not part of the computer system. The external system may communicate through a connection with the computer system. The connection may, for example, be a network connection. The external system may, for example, be a database management system that is configured to receive the pre-processed data and store it in a database for enabling analysis of the data. In one example, the external system may be a web server that manages requests which may be derived by the converter unit from the pre-processed data.

The monitoring data may thus be descriptive of hardware components of the computer system during operation of the computer system, descriptive of the environment of the computer system etc. For example, the monitoring unit may monitor environmental sensors and log events, wherein the monitoring data comprises the logged events. The monitoring unit may, for example, monitor and log the temperatures, voltages, CPU status, currents, memory usage, and fan speeds at the computer system, wherein the monitoring data comprises the logged data.

However, the size and the diversity of the monitoring data may render the management of the computer system inefficient. For example, the time series data may be collected in short intervals (such as minutes), so the data accumulates very rapidly. Thus, trying to understand the data formats before actually analysing it may cause unnecessary delays. In addition, the monitoring data may comprise irrelevant data whose analysis may cause extra delays and may lead to misleading results. The present subject matter may solve this issue by using a second processing unit which is referred to as converter unit.

The converter unit, the monitoring unit, and the main processing unit may be independent components of the computer system that may communicate with each other through one or more communication means. The converter unit may be configured to receive the monitoring data from the monitoring unit. The converter unit may pre-process the monitoring data. The resulting pre-processed data may then be provided by the converter unit for enabling the management of the computer system, to efficiently monitor and thus control computer system.

For example, the pre-processed data at the remote management system may be analysed, e.g., by one or more mining tools, to determine whether a service action at the computer system is needed. If the service action is needed, the remote management system may send a control signal or command to execute the service action at the computer system. The service action may, for example, be executed to fix a malfunction for the computer system. For example, if the room temperature is too high, the service action may be to repair an existing cooling system or use a new cooling system. In another example, if the log files of a given application running in debug mode at the computer system are too large, the service action may adapt the application to run in info mode instead of the debug mode. In another example, the service action may be a shut down, power-cycle, or reboot of the computer system. Thus, in response to sending the pre-processed data, the computer system may receive a command to perform a service action that controls its operation.

For example, the converter unit may automatically send the pre-processed data to the at least one remote management system. Alternatively, the converter unit may send the pre-processed data to the at least one remote management system upon receiving a request from the at least one remote management system. The data pre-processing may enable the manipulation and/or filtering of the monitoring data before it is used at the remote management system(s). This may ensure or enhance performance. Hence, instead of sending the data unconditionally to the remote management system(s), the converter unit may seamlessly be integrated in the existing computer system to improve the monitoring data reporting.

The processing capability of the converter unit may be smaller than the processing capability of the main processing unit. For example, the converter unit may comprise a microcontroller. The converter unit may, for example, comprise a minimal operating system. The minimal operating system may be an operating system that has been stripped of unnecessary components and provides only the functionality needed for a specific purpose e.g., performing the method of the converter unit according to the present subject matter.

According to one example, the computer system comprises a bus system connecting the main processing unit, the monitoring unit, and the converter unit, wherein the converter unit receives the monitoring data via the bus system. The bus system may be a single computer bus that connects the units of the computer system, combining the functions of a data bus to carry information, an address bus to determine where it should be sent or read from, and a control bus to determine its operation.

According to one example, the method further comprises: receiving by the converter unit further monitoring data from an operating system of the main processing unit, wherein the pre-processing is performed using the further received monitoring data. The operating system of the main processing unit may be referred to as base operating system. The further monitoring data may be descriptive of the software components being served by the base operating system. The further monitoring data may comprise values of the software parameters. This example may further improve the performance of the computer system as it enables to check the software part of the computer system, in addition to the hardware part provided by the monitoring data of the monitoring unit.

According to one example, the converter unit comprises an application comprising instructions that, when executed, perform at least one of the pre-processing step and the sending step. The application is containerized in a container. The container may be a fully functional and portable computing environment surrounding the application and keeping it independent from other parallelly running environments. The container may run the application in isolation by bundling related configuration files, libraries and dependencies. The container may, for example, be created from a container image. The container image may be a template for creating one or more containers. This example may be advantageous as it may render the execution of the application less dependent on the computer system. Using containers may improve the control of the computer system, e.g., if the administrator requires additional monitoring data or a different data format, the container can be easily adapted to the new needs and can be rapidly deployed and patched compared a non-containerized application.

According to one example, the converter unit comprises multiple applications comprising instructions that, when executed, perform at least one of the pre-processing step and the sending step. Each application of the multiple applications is containerized in a respective container. For example, the pre-processing may comprise multiple different types of pre-processing, wherein each type of pre-processing may result in its pre-processed data. Each application of the multiple applications may be configured to perform a respective type of pre-processing and perform the submission of the resulting pre-processed data. For example, the pre-processed data of each type of pre-processing may be sent to a distinct external system. This example may provide a modular processing of the monitoring data. This may particularly be advantageous if different external systems require different types and/or formats of the monitoring data which may be provided by the different applications.

According to one example, the method further comprises: receiving by the converter unit container images from one or more users, storing the container images in the converter unit, and creating the multiple containers using the respective container images. This may increase the usability of the converter unit as different users can decide the type of monitoring data they want to have by using distinct containers.

According to one example, the pre-processing of the monitoring data comprises: performing a first type analysis by executing a first container of the multiple containers, resulting in first pre-processed data, performing a second type analysis by executing a second container of the multiple containers, resulting in second pre-processed data; wherein the first pre-processed data is sent to the remote management system associated with the first container and the second pre-processed data is sent to another remote management system associated with the second container.

According to one example, the method further comprises: establishing a connection between the converter unit and the remote management system, for exclusive communication of data between the converter unit and the remote management system, and sending the pre-processed data to the remote management system through the established connection. For example, each unit of the converter unit, the monitoring unit and the main processing unit may comprise a respective network interface device to connect to a same network or different networks. This example may enable an isolation of the converter unit from the other units of the computer systems. This may secure data communicated by the converter unit. In case of multiple remote management systems, the converter unit may establish a connection with each of remote management systems and may send the pre-processed data to the multiple remote management systems via the connections respectively. In one example, the whole pre-processed data may be sent to each of the multiple remote management systems. Each of the remote management systems may analyse its part of the pre-processed data and provide a service action based on the analysis of that part. Alternatively, each of the remote management systems may analyse the whole pre-processed data and the results may be combined in order to (jointly) provide a service action based on the analysis results. In one example, the converter unit may send to each remote management system of the remote managements a portion of the pre-processed data that is associated with the each remote management system. This may be advantageous in case each remote management system may require a different type of pre-processing.

According to one example, the converter unit is configured to communicate with the monitoring unit and the main processing unit via a secure communication protocol. This example may further secure the communicated data by the converter unit because the internal communication is also secured through the secure communication protocol.

According to one example, the secure communication protocol requires at least one of: encryption of transmitted data, read only requests from the converter unit. Following the secure communication protocol, the converter unit may only perform read requests to the monitoring unit and the main processing unit. For example, the converter unit may be configured to send a read request to the monitoring unit and the main processing unit in order to receive the monitoring data from the monitoring unit and the main processing unit respectively. Additionally, or alternatively, the converter unit may receive the monitoring data in encrypted format according to an encryption protocol. The converter unit may decrypt the received encrypted data according to the encryption protocol e.g., using a decryption key, for performing the pre-processing of the monitoring data.

The converter unit may be configured to communicate with the monitoring unit and with the main processing unit using an internal IP protocol. According to one example, the converter unit is configured to communicate with the monitoring unit and the main processing unit via an application programming interface (API). For example, each of the monitoring unit and the main processing unit may comprise an agent that enables the communication through the API.

According to one example, the converter unit is a system on chip (SoC) embedded to a motherboard of the computer system. The main processing unit and the monitoring unit are embedded to the motherboard, wherein a bus system connects the units on the motherboard. This example may provide the converter unit as an integrated onboard technology. This may enable a flexible implementation of the converter unit. The converter unit may be provided as a universal plug-in that can easily be inserted in computer systems.

According to one example, the monitoring unit comprises a service processor. The main processing unit comprises a base operating system (OS). The base OS is configured to acquire data descriptive of software components of the computer system. The service processor is configured to acquire data descriptive of hardware components of the computer system, wherein the monitoring data comprises the acquired data. The service processor may be a microcontroller that may be embedded in a motherboard, a PCI card, or on the chassis of the computer system. The service processor is independent from the main processing unit and may be accessible through an Ethernet interface, for Out-of-Band management or sideband management.

According to one example, the pre-processing comprises at least one of the following: filtering the received monitoring data using one or more filters; analysing the received data and providing one or more notifications and/or instructions based on the analysis; or formatting the filtered data according to a defined format. Filtering the data may comprise selecting a portion of the monitoring data that may be of interest at the remote management system, e.g., a filter may for example require monitoring data obtained during a given time period e.g., during the day, because during the night the computer system may not be in use and thus its monitoring data may not be needed. In another example, a filter may perform data cleansing by detecting wrong data or data that cannot be used for analysis and removing it from the monitoring data. The formatting of the monitoring data may, for example, comprise determining attributes (such as CPU usage attribute, or temperature etc.) whose values are part of the monitoring data, and using the attributes to provide structured data e.g., in the form of table records or graphs etc.

For example, the analysis of the monitoring data may reveal that a temperature sensor is higher than a threshold or lower than a threshold, in response to which the converter unit may notify the remote management system accordingly or instruct the remote management system to perform a specific predefined service action. In another example, the computer system may be comprised in a fridge, wherein the analysis of the monitoring data may indicate that a malfunction of the fridge (e.g., a component of the fridge breaks) and may instruct accordingly the remote management system to fix or solve the malfunction.

According to one example, the main processing unit comprises at least one hypervisor supporting virtual machines. The at least one hypervisor may be a first type and/or second type hypervisor.

According to one example, the remote management system is a database management system or a web server.

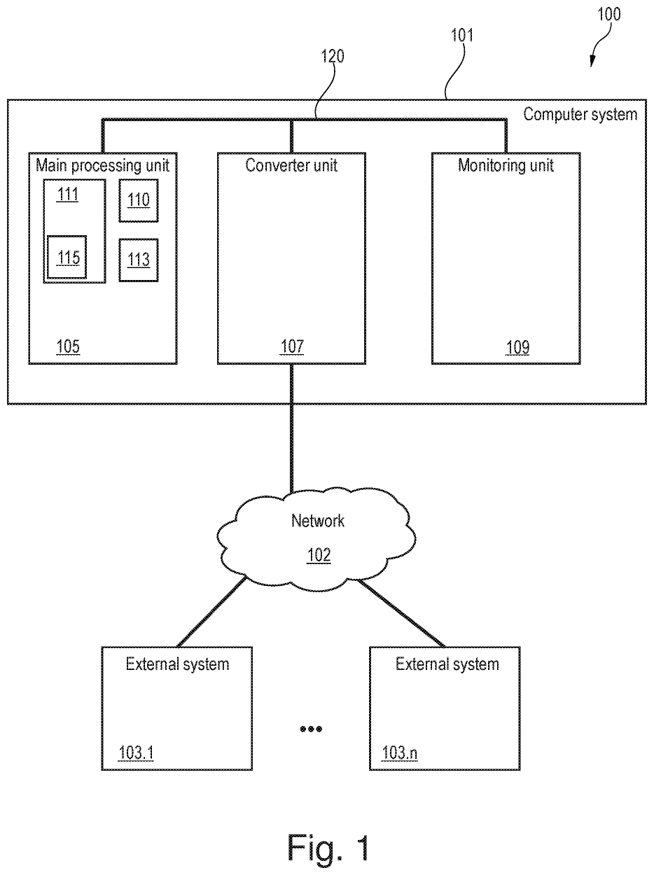

FIG. 1 depicts a management system in accordance with an example of the present subject matter.

The management system 100 comprises a computer system 101 and one or more external systems 103.1 through 103.n. The computer system 101 comprises a main processing unit 105, a converter unit 107 and a monitoring unit 109. The main processing unit 105 may comprise a processor 110 and a main memory 111. The memory 111 may comprise software. The software may include a suitable operating system (OS) 115. The OS 115 may control the execution of other computer programs. The main processing unit 105 may further comprise a network interface device 113 for coupling to a network such as network 102.

The components of the computer system 101 may be coupled to a bidirectional system bus 120. For example, the converter unit 107, the monitoring unit 109, the processor 110, the memory 111, and the network interface device 113 may be coupled to the bus 120.

The converter unit 107 may be configured to transmit and receive data from the external systems 103.1-n over a network 102. The data may be transmitted and received between the converter unit 107 and the external system(s) using a communication protocol such as the Simple Network Management Protocol (SNMP) protocol. The network 102 may be an IP-based network for communication between the converter unit 107 and any external system, client and the like via a broadband connection. The network 102 transmits and receives data between the converter unit 107 and external systems 103.1-n. The network 102 may be implemented in a wireless fashion, e.g., using wireless protocols and technologies, such as WiFi, WiMax, etc. The network 102 can also be a packet-switched network such as a local area network, wide area network, metropolitan area network, Internet network, or other similar type of network environment. The network 102 may be a fixed wireless network, a wireless local area network (LAN), a wireless wide area network (WAN) a personal area network (PAN), a virtual private network (VPN), intranet or other suitable network system and includes equipment for receiving and transmitting signals.

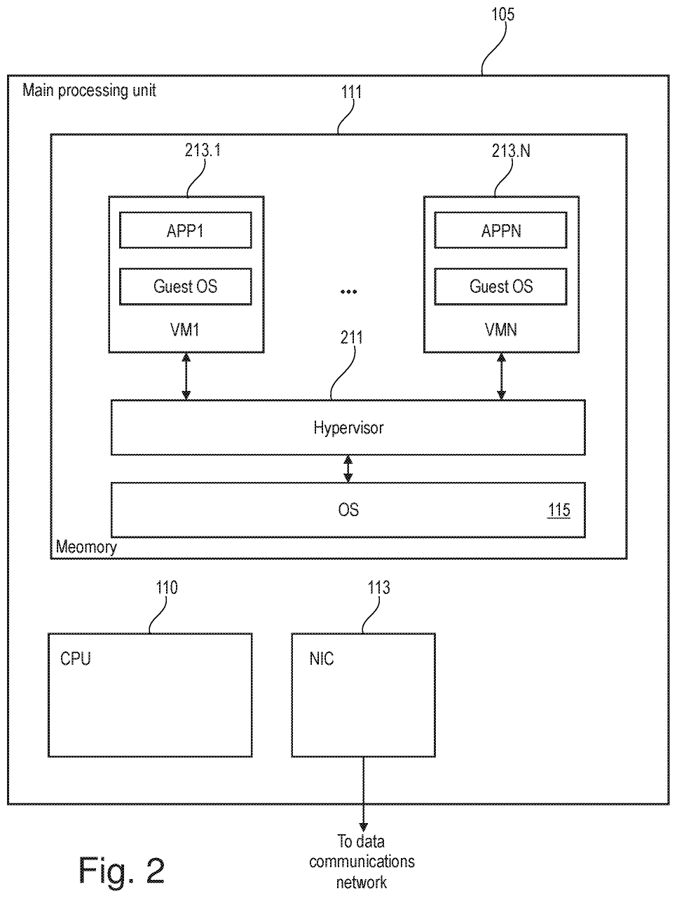

FIG. 2 depicts a block diagram of an example implementation of the main processing unit 105 of FIG. 1.

The processing unit 105 may be configured to execute applications APP1-APPN using virtual machines 213.1-213.N. A bootloader (not shown) may be used to configure and start at least part of the applications APP1-APPN. As shown in FIG. 2, the memory 111 may include a hypervisor 211 that is up and running. The hypervisor 211 may, for example, be implemented as a software layer that runs directly on the computing hardware of the processing unit 105 or may be implemented as part of the OS 115 of the processing unit 105. The hypervisor 211 may be configured to provide virtualized hardware elements for each virtual machine 213.1-N. The hypervisor 211 may instantiate any number of Virtual Machines (VMs). As shown in FIG. 2, the hypervisor 211 may instantiate VM instances 213.1-N. For each VM, the hypervisor 211 may allocate a chunk of memory and other resources e.g., each VM 213.1-N provides a virtualized computing platform with a virtual CPU, memory, storage, and networking interfaces. After being defined or created, the VMs 213.1-N may be initiated or booted using, for example, the bootloader. FIG. 2 shows, for example, the VMs 213.1-N after being booted. Each of the VMs 213.1-N comprises a guest operating system and the application that is to be executed on the VMs.

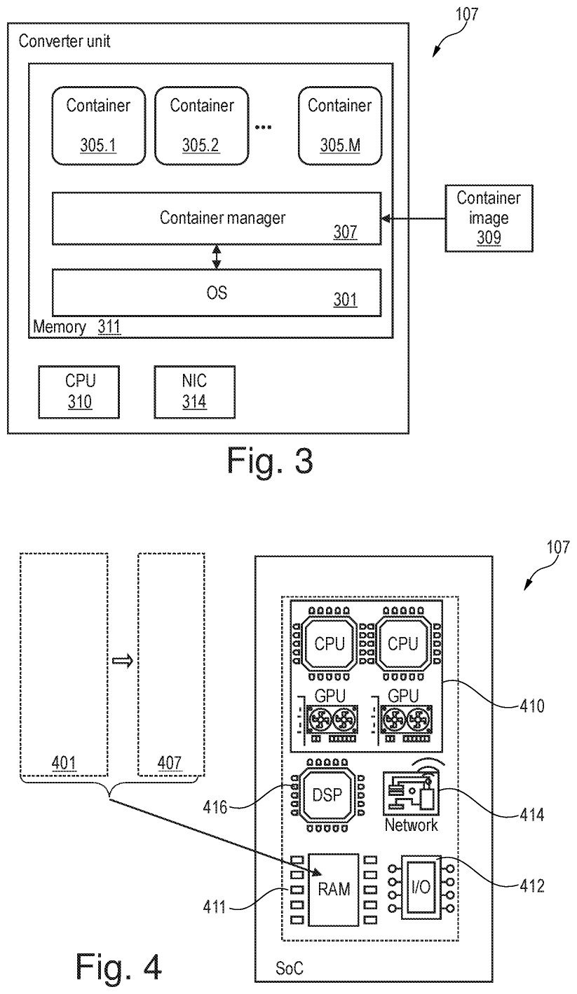

FIG. 3 depicts a processing unit in accordance with an example of the present subject matter. FIG. 3 provides an example implementation of the converter unit 107 as a container-based virtualization system. The converter unit 107 comprises a memory 311 and other hardware components including, for example, a processor 310 and a network interface device 314 for coupling to the network 102.

For example, the memory 311 may comprise an operating system 301. The operating system 301 may be a minimal operating system. The memory 311 may comprise a container manager 307 executed at least in part by the operating system 301 for developing, delivering, installing, and executing software containers. The container manager 307 may for example be Docker® container manager or Pod Manager (PODMAN™) container manager. The converter unit 107 comprises software containers 305.1-M. The containers 305.1-M may be created using the container manager 307. In another example, a container of the containers 305.1-M may be received or imported and integrated in the converter unit 107 e.g., the received container may have been built in another system that has a same configuration (e.g., kernel configuration) as the converter unit 107.

The operating system 301 in conjunction with the container manager 307 provides isolation between software processes executing in the converter unit 107 such as containers 305.1-M. For example, the processes may be provisioned to have a private view of the operating system 301 such that two processes cannot access each other's resources. Although isolated, the processes may still be capable of intercommunication such as by way of network connections or the like between the processes in the same way as unrelated and isolated computer systems can communicated via a network if configured and permitted to do so.

The container manager 307 may for example be configured to receive a container image 309 for instantiation, installation, and/or execution in the operating system 301. The container image 309 may be created and/or modified by the container manager or another software component such as an installer. The container image 309 may be a software component for execution as an isolated process in the operating system 301. For example, the container image 309 may be a Docker® image obtained from a container repository such as the Docker® registry. For example, the container image 309 may be a read-only template with instructions for creating a container. Using the container image 309 a container may be instantiated by the container manager 307 for execution as one or more processes in the operating system 301.

Each of the containers 305.1-M may be configured to perform a respective task or application. The containers 305.1-M may, for example, enable to perform the pre-processing of the monitoring data and the transmission of the pre-processed data according to the present subject matter. For example, the pre-processing step may perform multiple tasks. The tasks may be assigned to different pre-processing types such as a task of providing pre-processed data related to the CPU, and another task for providing pre-processed data related to the memory etc. In another example, the tasks may be assigned to different stages or phases of the pre-processing step e.g., such as cleansing task, selection task etc. Each container of the containers 305.1-M may be configured to perform a respective task of the tasks. The result of each task may be pre-processed data. The resulting pre-processed data of all tasks may be combined and sent (e.g., by one of the containers) to one or more external systems. If sent to multiple external systems, each external system may check the respective part of the pre-processed data and decide its service actions. Or, the multiple external systems may analyse the whole pre-processed data and combine their analysis result in order to decide (jointly) service actions on the computer system. Alternatively, the pre-processed data of each task may be sent by the respective container to a respective external system. This may be advantageous in case each external system may require a different type of pre-processing.

FIG. 4 depicts a processing unit in accordance with an example of the present subject matter. FIG. 4 provides an example implementation of the converter unit 107 as a SoC. The converter unit 107 comprises a processor 410 comprising central processing units (CPUs) and graphics processing units (GPUs). The converter unit 107 comprises a random-access memory (RAM) 411 and an I/O device 412. The converter unit 107 further comprises a network interface device 414 for coupling to the network 102. The converter unit 107 further comprises a digital signal processor (DSP) 416 e.g., for digital signal processing. As illustrated in FIG. 4, the RAM 411 may comprise a minimal operating system 401 such as microkernel Linux® and a container manager 407 such as PODMAN™ container manager or Docker® container manager for enabling containers in the converter unit 107. The containers may be configured to perform the pre-processing step and the transmission of the pre-processed data as described with reference to FIG. 3.

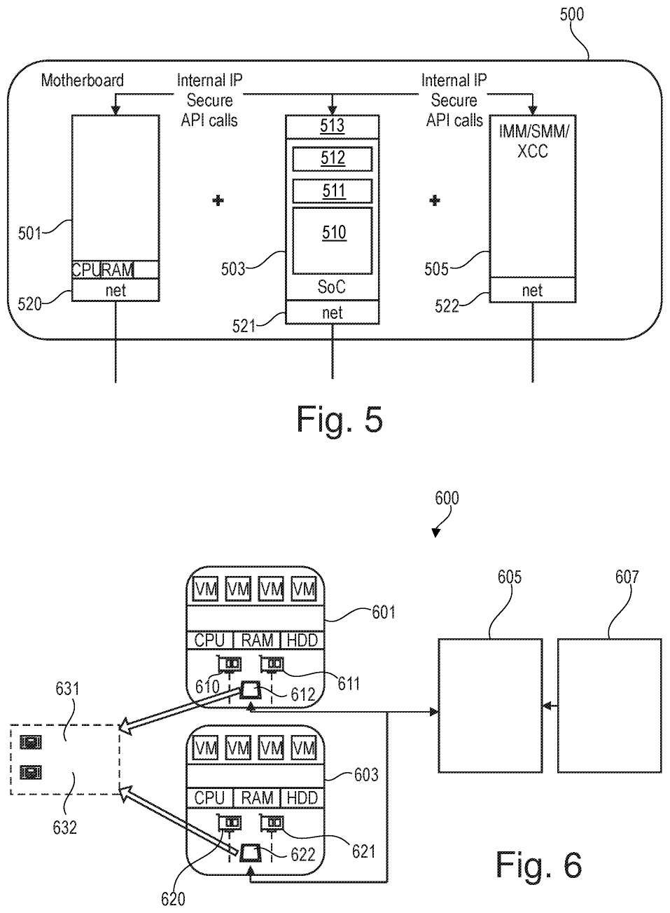

FIG. 5 depicts a motherboard 500 in accordance with an example of the present subject matter. FIG. 5 provides an example implementation of the computer system 101. A main processing unit 501, a converter unit 503 and a monitoring unit 505 are embedded in the motherboard 500. The main processing unit 501 may be provided with hardware components such as a CPU and a RAM having a base OS and a hypervisor of type 1 and type 2. The main processing unit 501 may further be provided with a network interface 520 for communication with a network.

The converter unit 503 may be a SoC provided with partitions 510 for data, containers, and container images. The converter unit 503 may comprise partition 511 for containers such as PODMAN™ containers. The converter unit 503 may comprise partition 512 for images such as PODMAN™ images. The converter unit 503 may comprise in component 513 a microkernel OS, drivers, and a container manager such as PODMAN™ container manager for managing the containers. The converter unit 503 may further be provided with a network interface 521 for communication with the network. The monitoring unit 505 may be a service processor such as Integrated Management Module (IMM), System Management Module (SMM) or XClarity Controller (XCC) which is configured to communicate according to a SNMP protocol.

The monitoring unit 505 may further be provided with a firmware such as BIOS or UEFI and a network interface 522 for communication with the network. The implementation of FIG. 5 enables the three units to independently connect to the network using their respective network interfaces. As indicated in FIG. 5, the main processing unit 501, converter unit 503 and monitoring unit 505 may communicate with each other using internal IP secure API calls.

FIG. 6 depicts a management system 600 in accordance with an example of the present subject matter. The management system 600 comprises multiple computer systems e.g., two computer systems 601 and 603. The management system 600 further comprises a database system 605 and an analysis system 607. The database system 605 may, for example, comprise InfluxDB®. The analysis system 607 may, for example, comprise Grafana®. The computer system 601 may comprise hardware components such as RAM, CPU, and HDD storage. The RAM may comprise a base OS 610 and hypervisor such as VMware vSphere Hypervisor (ESXi) or VMware ESXi™. The computer system 601 may comprise a service processor 611 such as IMM, SMM, or XCC and a SoC 612 according to the present subject matter. The SoC 612 may, for example, comprise a converter unit configured as a container-based virtualization system having one or more containers. This is indicated in FIG. 6, where the SoC 612 is associated with a container name 631 (e.g., the container name may be “snmp_exporter_Prometheus™”) of a container that may execute the pre-processing of the monitoring data and transmission of the pre-processed data according to the present subject matter. The result of the pre-processing may be sent to the database system 605.

The computer system 603 may comprise a service processor 621 such as IMM, SMM, or XCC and a SoC 622 according to the present subject matter. The computer system 603 may comprise hardware components such as RAM, CPU, and HDD storage. The RAM may comprise a base OS 620 and hypervisor such as VMware vSphere Hypervisor (ESXi) or VMware ESXi™. The SoC 622 may, for example, comprise a processing unit configured as a container-based virtualization system having one or more containers. This is indicated in FIG. 6, where the SoC 622 is associated with a container name 632 (e.g., the container name may be “snmp_exporter_InfluxDB®”) of a container that may execute the pre-processing of the monitoring data and transmission of the pre-processed data according to the present subject matter. The result of the pre-processing may be sent to the database system 605. The analysis system 607 may analyse the monitoring data and based on that analysis, service actions may be performed in the computer system 601 and/or computer system 603.

As indicated in FIG. 6, the present subject matter may be advantageous as the converter unit may be provided as a universal plug-in that can be installed in different computer systems. The present subject matter may further be advantageous as it makes use of containers at the converter unit so that each provided converter unit may have its own container e.g., each different container (converter unit) may perform a different type of pre-processing.

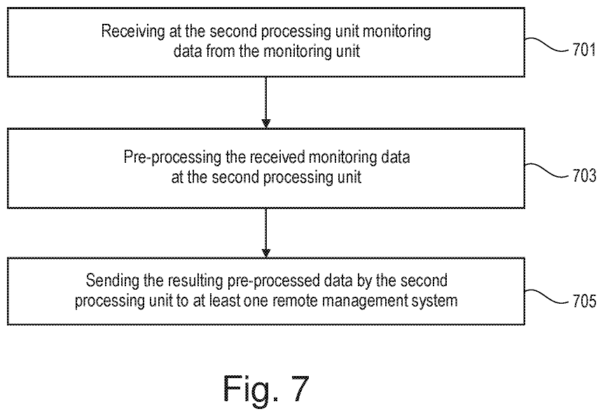

FIG. 7 is a flowchart of a method for monitoring a computer system in accordance with an example of the present subject matter. For simplification purpose, the method of FIG. 7 is described with reference to FIG. 1's system but it is not limited to what is depicted (or described in association with) FIG. 1. The converter unit 107 may receive in step 701 monitoring data from the monitoring unit 109. The converter unit 107 may pre-process in step 703 the received monitoring data. Step 703 may be referred to as pre-processing step. The converter unit 107 may send in step 705 the resulting pre-processed data to at least one remote management system 103.1-n. Step 705 may be referred to as sending step. In one example implementation, steps 701 to 705 may be repeatedly performed. For example, steps 701 to 705 may be repeated until a stop criterion is fulfilled. The stop criterion may, for example, require a maximum number of repetitions, or require a stop command is received at the second processing unit.

The present subject matter may comprise the following clauses.

Clause 1. A method for monitoring a computer system, the computer system comprising a first processing unit, herein referred to as main processing unit, the computer system further comprising a monitoring unit for monitoring operation of the computer system, the method comprising: providing the computer system with a second processing unit, herein referred to as converter unit, that is configured to communicate with the monitoring unit and the main processing unit; receiving at the converter unit monitoring data from the monitoring unit; pre-processing the received monitoring data at the converter unit; sending the resulting pre-processed data by the converter unit to at least one remote management system.

Clause 2. The method of clause 1, the computer system comprising a bus system connecting the main processing unit, the monitoring unit and the converter unit, wherein the converter unit receives the monitoring data via the bus system.

Clause 3. The method of any of the preceding clauses 1 to 2, further comprising: receiving by the converter unit further monitoring data from an operating system of the main processing unit, wherein the pre-processing is performed using the further received monitoring data.

Clause 4. The method of any of the preceding clauses 1 to 3, the converter unit comprising an application comprising instructions that, when executed, perform at least one of the pre-processing and the sending, the application being containerized in a container.

Clause 5. The method of any of the preceding clauses 1 to 3, the converter unit comprising multiple applications comprising instructions that, when executed, perform at least one of the pre-processing and the sending, each application of the multiple applications being containerized in a respective container.

Clause 6. The method of clause 5, further comprising: receiving by the converter unit container images from users; storing the container images in the converter unit; creating the multiple containers using the respective container images.

Clause 7. The method of clause 5 or 6, the pre-processing comprising: performing a first type analysis by executing a first container of the multiple containers, resulting in first pre-processed data; performing a second type analysis by executing a second container of the multiple containers, resulting in second pre-processed data; wherein the first pre-processed data is sent to the remote management system associated with the first container and the second pre-processed data is sent to another remote management system associated with the second container.

Clause 8. The method of any of the preceding clauses 1 to 7, further comprising: establishing a connection between the converter unit and the remote management system, for exclusive communication of data between the converter unit and the remote management system; and sending the pre-processed data to the remote management system through the established connection.

Clause 9. The method of any of the preceding clauses 1 to 8, the converter unit being configured to communicate with the monitoring unit and the main processing unit via a secure communication protocol.

Clause 10. The method of clause 9, the secure communication protocol requiring at least one of: encryption of transmitted data, read only requests from the converter unit.

Clause 11. The method of clause 9 or 10, the converter unit being configured to communicate with the monitoring unit and the main processing unit via an application programming interface whose agents are installed in the monitoring and main processing units.

Clause 12. The method of any of the preceding clauses 1 to 11, the converter unit being a system on chip (SoC) attached to a motherboard of the computer system, the main processing unit and the monitoring unit being attached to the motherboard, wherein a bus system connects the units on the motherboard.

Clause 13. The method of any of the preceding clauses 1 to 12, the monitoring unit comprising a service processor, the main processing unit comprising a base operating system (OS), the base OS being configured to acquire data descriptive of software components of the computer system, the service processor being configured to acquire data descriptive of hardware components of the computer system, wherein the monitoring data comprises the acquired data.

Clause 14. The method of any of the preceding clauses 1 to 13, the pre-processing comprising at least one of the following: filtering the received monitoring data using one or more filters; analysing the received data and providing one or more instructions based on the analysis; or formatting the filtered data according to a defined format.

Clause 15. The method of any of the preceding clauses 1 to 14, the main processing unit comprising a hypervisor supporting virtual machines.

Clause 16. The method of any of the preceding clauses 1 to 15, the remote management system being a database management system or a web server.

Clause 17. The method of any of the preceding clauses 1 to 16, further comprising: in response to sending the pre-processed data, receiving at the computer system a control signal for controlling operation of the computer system.

Clause 18. The method of any of the preceding clauses 1 to 17, wherein the receiving, the pre-processing and the sending is repeatedly performed by the converter unit.

Computing environment 800 contains an example of an environment for the execution of at least some of the computer code involved in performing the inventive methods, such as improved computer system monitoring code 900. In addition to block 900, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 900, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

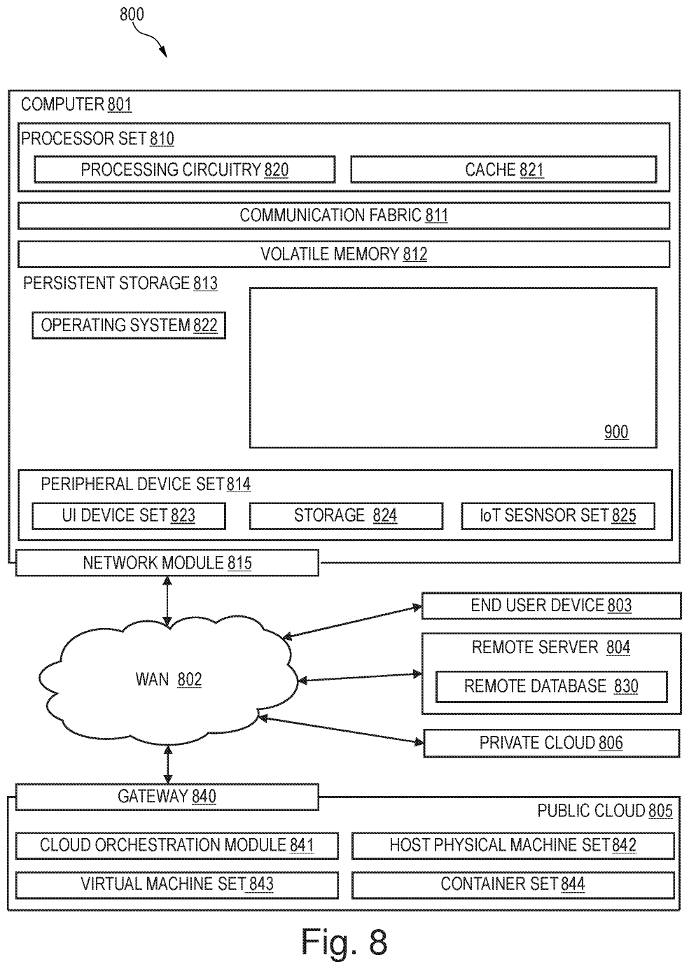

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 900 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 900 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

1. A method comprising:
monitoring a computer system that includes:
a main processing unit;
a monitoring unit for monitoring operation of the computer system; and
a converter unit that is configured to communicate with the monitoring unit and the main processing unit, wherein the computing system is monitored by:
receiving at the converter unit monitoring data from the monitoring unit;
pre-processing the received monitoring data at the converter unit; and
sending the resulting pre-processed data by the converter unit to at least one remote management system.

2. The method of claim 1, the computer system comprising a bus system connecting the main processing unit, the monitoring unit, and the converter unit, wherein the converter unit receives the monitoring data via the bus system.

3. The method of claim 1, further comprising:
receiving by the converter unit further monitoring data from an operating system of the main processing unit, wherein the pre-processing is performed using the further received monitoring data.

4. The method of claim 1, the converter unit comprising an application comprising instructions that, when executed, perform at least one of the pre-processing and the sending, the application being containerized in a container.

5. The method of claim 1, the converter unit comprising multiple applications comprising instructions that, when executed, perform at least one of the pre-processing and the sending, each application of the multiple applications being containerized in a respective container.

6. The method of claim 5, further comprising:
receiving by the converter unit container images from users;
storing the container images in the converter unit; and
creating the multiple containers using the respective container images.

7. The method of claim 5, the pre-processing comprising:
performing a first type analysis by executing a first container of the multiple containers, resulting in first pre-processed data; and
performing a second type analysis by executing a second container of the multiple containers, resulting in second pre-processed data,
wherein the first pre-processed data is sent to the remote management system associated with the first container and the second pre-processed data is sent to another remote management system associated with the second container.

8. The method of claim 1, further comprising:
establishing a connection between the converter unit and the remote management system, for exclusive communication of data between the converter unit and the remote management system; and
sending the pre-processed data to the remote management system through the established connection.

9. The method of claim 1, the converter unit being configured to communicate with the monitoring unit and the main processing unit via a secure communication protocol.

10. The method of claim 9, the secure communication protocol requiring at least one of encryption of transmitted data and/or read only requests from the converter unit.

11. The method of claim 9, the converter unit being configured to communicate with the monitoring unit and the main processing unit via an application programming interface whose agents are installed in the monitoring and main processing units.

12. The method of claim 1, the converter unit being a system on chip (SoC) attached to a motherboard of the computer system, the main processing unit and the monitoring unit being attached to the motherboard, wherein a bus system connects the units on the motherboard.

13. The method of claim 1, the monitoring unit comprising a service processor, the main processing unit comprising a base operating system (OS), the base OS being configured to acquire data descriptive of software components of the computer system, the service processor being configured to acquire data descriptive of hardware components of the computer system, wherein the monitoring data comprises the acquired data.

14. The method of claim 1, the pre-processing comprising at least one of the following:
filtering the received monitoring data using one or more filters;
analysing the received data and providing one or more instructions based on the analysis; or
formatting the filtered data according to a defined format.

15. The method of claim 1, the main processing unit comprising a hypervisor supporting virtual machines.

16. The method of claim 1, the remote management system being a database management system or a web server.

17. The method of claim 1, further comprising: in response to sending the pre-processed data, receiving at the computer system a control signal for controlling operation of the computer system.

18. The method of claim 1, wherein the receiving, the pre-processing and the sending is repeatedly performed by the converter unit.

19. A computer program product comprising a computer-readable storage medium having computer-readable program code embodied therewith, the computer-readable program code configured to implement the method of claim 1.

20. A system comprising:
a processor;
a monitoring unit for monitoring operation of the computer system;
a converter unit that is configured to communicate with the monitoring unit and the main processing unit; and
a memory in communication with the processor, the memory containing instructions that, when executed by the processor, cause the processor to monitor a computer system by:
receive monitoring data from the monitoring unit;
pre-process the received monitoring data;
send the resulting pre-processed data to at least one remote management system.

21. The system of claim 20, wherein the processor is a system on chip (SoC).

22. The system of claim 21, wherein the SoC is attached to a motherboard of the computer system.
